(19) United States
(12) Patent Application Publication
(10) Pub. No.: US 2024/0070273 A1
(43) Pub. Date: Feb. 29, 2024

(54) SYSTEMS, DEVICES, AND METHODS FOR GENERATING CYBERSECURITY THREAT INTELLIGENCE

(71) Applicant: SAUDI ARABIAN OIL COMPANY, Dhahran (SA)

(72) Inventors: Fahad Abdulaziz ALMOGBIL, Khobar (SA); Rakan Hussain YAMANI, Dammam (SA)

(73) Assignee: SAUDI ARABIAN OIL COMPANY, Dhahran (SA)

(21) Appl. No.: 17/822,477

(22) Filed: Aug. 26, 2022

(51) Int. Cl. G06F 21/56; G06F 21/57

(52) U.S. Cl. CPC G06F 21/564; G06F 21/57; G06N 20/00

(57) ABSTRACT

A method may include receiving a smart contract, which includes a binary file, from a contributor on a blockchain network, validating the smart contract, analyzing the binary file for malicious features, and generating a cybersecurity threat intelligence report using a contractual transaction incentivizing malware submission by the contributor. In some instances, analyzing the binary file comprises receiving the binary file by a feature extractor operable to extract one or more features based on one or more of analyzing the binary file using one or more of a header of the binary file, an image visualization of the binary file, natural language processing of application programming interface (API) calls, encoded strings, assembly instructions of the binary file, and sentiment analysis, and wherein the method further comprises delivering an extracted feature to a threat evaluator.

### FIELD OF THE DISCLOSURE

The present disclosure relates generally to malware detection and mitigation and, more particularly, to systems and methods for generating cybersecurity threat intelligence.

### BACKGROUND OF THE DISCLOSURE

Cybersecurity threat intelligence refers to information mined from malicious programs, or malware, including similarities to previously identified (e.g., known) threats and mitigation techniques based upon these similarities.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method may include receiving a binary file from a contributor on a blockchain network using a contractual transaction incentivizing malware submission by the contributor. The method may include analyzing the binary file for malicious features. Finally, the method may generate a cybersecurity threat intelligence report from the binary file.

In another embodiment, a non-transitory computer-readable medium may store machine-readable instructions, which, when executed by a processor of an electronic device, may cause the electronic device to receive a binary file from a contributor on a blockchain network using a contractual transaction incentivizing malware submission by the contributor. The electronic device may also be caused to perform analysis on the binary file to determine if the binary file is malware, and then to generate a cybersecurity threat intelligence report from the binary file.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is an example of a system for generating a cybersecurity threat intelligence report.

FIG. 2 is an example of a method for generating a cybersecurity threat intelligence report.

FIG. 3 is an example of a transaction involving the contribution of a binary file to be analyzed.

FIG. 4 is an example of a method for training a feature extractor and a cybersecurity threat evaluator.

FIG. 5 is an example of a method for generating a cybersecurity threat intelligence report.

FIG. 6 depicts an example computing environment that can be used to perform methods according to an aspect of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to cybersecurity threat intelligence gathering, to include malware detection and mitigation. Cybersecurity threats, including malware, pose a risk to systems and networks. Early detection or discovery of such threats can mitigate or reduce an amount of damage that such threats cause to one or more systems or a network to which the one or more systems are coupled. Cybersecurity threat intelligence enables proactive responses to cybersecurity threats before these threats compromise the one or more systems.

Examples are presented herein for generating cybersecurity threat intelligence reports while limiting Sybil attacks on the intelligence generation process. In some examples, an analyzer includes a feature extractor for extracting features from binary files and a cybersecurity threat evaluator for determining whether the binary file is malware or benign, classifying the malware based upon known threats as well as new commonalities, and generating a cybersecurity threat intelligence report containing at least the classifications made by the cybersecurity threat classifier. In some examples, the feature extractor extracts header information and strings from the file, and additionally visualizes the binary file as an image. In some examples, the cybersecurity threat evaluator classifies the binary file to known malware families, known advanced persistent threats, and additional classifications based upon found malware commonalities. A malware family may constitute a set of programs which contain enough overlapping code (or the same code base) to be considered a part of the same group, while an advanced persistent threat is often malware which remains within a system for an extended period prior to launching an attack. In some examples, the feature extractor cybersecurity threat evaluator employs a trained machine learning model for extracting features, and the cybersecurity threat evaluator employs a machine learning model for classifying malware. In various examples, machine learning techniques use a database of known cybersecurity threat information (e.g. the MITRE ATT&CK® framework) to train the feature extractor, the cybersecurity threat evaluator, or a combination thereof. The analyzer distributes the cybersecurity-threat intelligence report to consumers to enable the consumers to prevent a cyber-attack before it happens.

In some examples, the analyzer is a component of a system. The system is coupled to a blockchain network, for example. The binary files are contributed by users (e.g., contributors) as part of a smart contract in exchange for a reward for reporting malicious files, for example, and all transactions are verified by miners on the blockchain network. In some examples, the smart contract may include a deposit from the contributor. Upon confirmation from the system that the contributed binary file contains malware, the deposit is returned to the contributor along with a payment for the contribution. However, if the system reports that the contributed binary file is benign, the deposit is retained by the system and the contributor is not paid for their contribution. The submission of a deposit may deter bad actors from falsely submitting files in small or large attacks, thus enabling Sybil resistance within the system. Conversely, the contractual nature of the submission to the system incentivizes and rewards the contributor for raising awareness of the specific malware and helping build safeguards against it.

In various examples, contributors may be assigned a reliability rating, which increases with a successful contribution of malware and decreases with submission of a benign file. Through the tracking of contributor reliability and a self-contained system, the architecture offers traceability with an indication of source trustworthiness. In some examples, the generated cybersecurity threat intelligence report may be distributed to a consumer in exchange for a fee. The generated cybersecurity threat intelligence report may additionally contain mitigation strategies for the malware based upon classifications. The consumer may be able to submit feedback based upon the contents of the report, which may be used to further train the machine learning models employed in the feature extractor and cybersecurity threat evaluator. Cybersecurity threat intelligence may additionally be used to profile the malicious third party originator of a binary file, as either an individual or as a member of a group, which generates the threat or attack. The above arrangements provide several advantages, including addressing critical security concerns such as traceability, Sybil resistance, and privacy. In addition, trustworthiness of data collected from various channels for cybersecurity threat intelligence is ascertained.

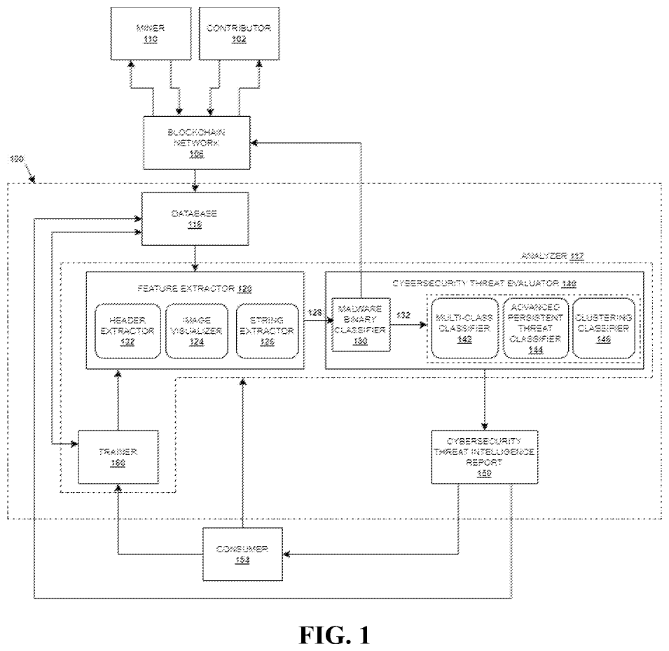

FIG. 1 is a block diagram of a system 100 for generating a cybersecurity threat intelligence report 150 in accordance with certain embodiments. The system 100 may couple to a blockchain or distributed network, for example the blockchain network 106. The system 100 includes modules configured in software and/or hardware and operable as a database 116 and an analyzer 117. In certain embodiment, the blockchain network 106 may employ an Inter-Planetary File System (IPFS). While examples are presented herein wherein the one or more packets are presented as IPFS packets, in other examples, the one or more packets may be based on a different communication protocol. The database 116 may be stored on local volatile and/or non-volatile memory or on an external server, but may additionally be stored on any device accessible by the system 100. The database 116 may store known malware binary files, known benign binary files, or a combination thereof. The database 116 may be a MONGODB®, for example.

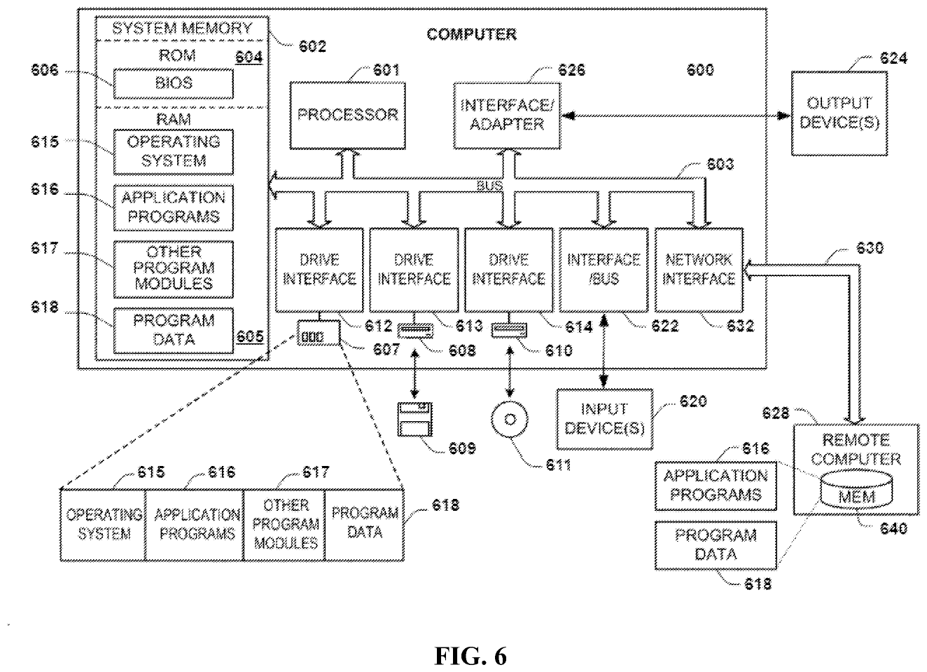

The analyzer 117 includes a feature extractor 120, a cybersecurity threat evaluator 140 and a trainer 160, some or all of which may be configured as hardware and/or software components. In some examples the feature extractor 120, the cybersecurity threat evaluator 140, the trainer 160, or a combination thereof can be implemented as machine-readable instructions that can be stored in memory (e.g., a memory 612, as shown in FIG. 6) and executed by a processor (e.g., a processor 602, as shown in FIG. 6). By way of example, the memory can be implemented, for example, as a non-transitory computer storage medium, such as volatile memory (e.g., random access memory (RAM), such as DRAM), non-volatile memory (e.g., a hard disk drive, a solid-state drive, a flash memory, or the like), or a combination thereof. The processor may be implemented, for example, as a processor core. The memory can store machine-readable instructions that can be retrieved and executed by the processor.

In certain embodiments, the contributor 102 may be a user-associated electronic device for providing a binary file to system 100 via the blockchain network 106. In certain embodiments the miner 110 may be configured to mine blocks and verify transactions in return for payment. In certain embodiments, the consumer 154 may include a user-associated component that may receive a cybersecurity threat intelligence report from the analyzer 117 and transmit feedback and payments to the analyzer. The contributor 102, the miner 110, and the consumer 154 may be members of the coupled blockchain network 106. Additionally, in some embodiments, the contributor 102, the miner 110, and the consumer 154 may be the operators of the electronic device 600 and may contribute, miner, or receive the cybersecurity threat intelligence report from the device described below in FIG. 6.

In some examples, in an initial transaction phase, the contributor 102 may transmit for evaluation a possible malware file as a binary file, which is added to the blockchain network 106 along with a deposit, which may be in cryptocurrency. In certain embodiments, the transaction, which may include a smart contract, is transmitted to the miner 110 for validation. The miner 110 then transmits a validation indication to the system 100 via the blockchain network 106 as a safeguard against unverified information from entering the network. In response to the validation indication indicating that the transaction is invalid, the smart contract is terminated, the transaction data is discarded, and the deposit may be retained by the system 100. In response to the validation indication indicating that the transaction is valid, the smart contract is enacted, and the remainder of the process may proceed. The binary file may then be added to the database 116 from a trusted source that may be traced.

The analyzer 117 may retrieve a copy of the binary file from the database 116. The copy of the binary file may be received by the feature extractor 120 which may employ one or more extraction techniques. In some examples, the feature extractor 120 includes a header extractor 122, which extracts features such as header information, exported functions, imported functions, section information, and general file information. The header extractor 122 enables detection of malicious WINDOWS portable executable files, for example. In some instances, the feature extractor 120 includes an image visualizer 124, which converts a binary sequence into one or more color model images for further analysis. The color model images may be grayscale images, red-green-blue (RGB) images, or hue-saturation-value (HSV) images, for example. The image visualizer 124 may enable identification of intensity-based or texture-based features that may be indiscernible by a human viewer. In some examples, the feature extractor 120 may include a string extractor 126, which can extract features using sentiment analysis or other similar natural language processing (NLP) technique. The string extractor 126 may extract features by performing sentiment analysis on application programming interface (API) calls made by the binary file, character strings within the binary file, and assembly-language instructions performed as a result of executing the binary file, for example. The character strings may be generated using an encoding technique such as an American Standard Code for Information Interchange (ASCII) format, a Unicode format, an American National Standards Institute (ANSI) format, or other suitable technique for encoding data. Those skilled in the art will appreciate that the feature extractor 120 may include additional extraction techniques not expressly recited herein without departing from the scope of this disclosure.

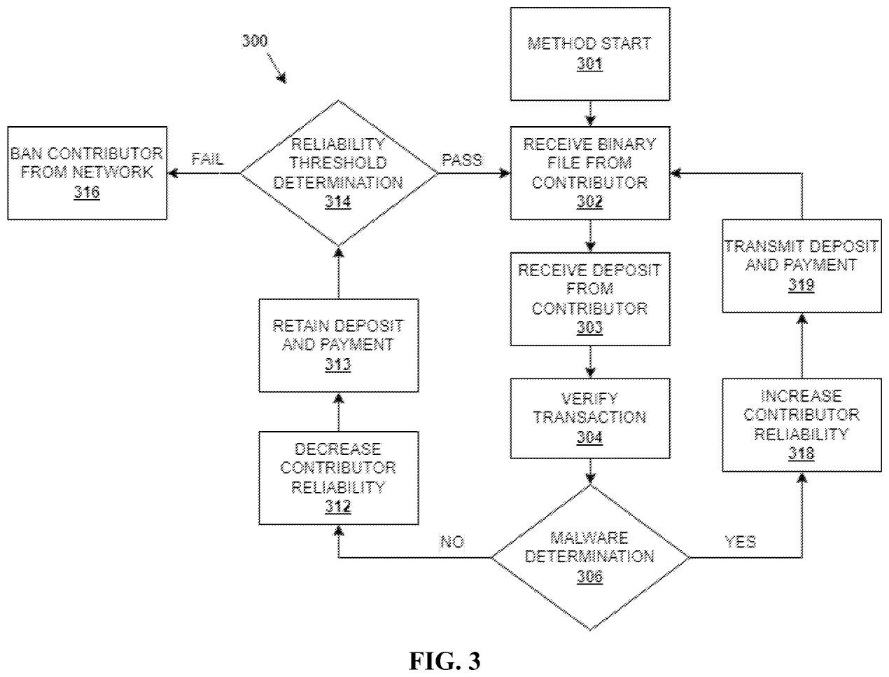

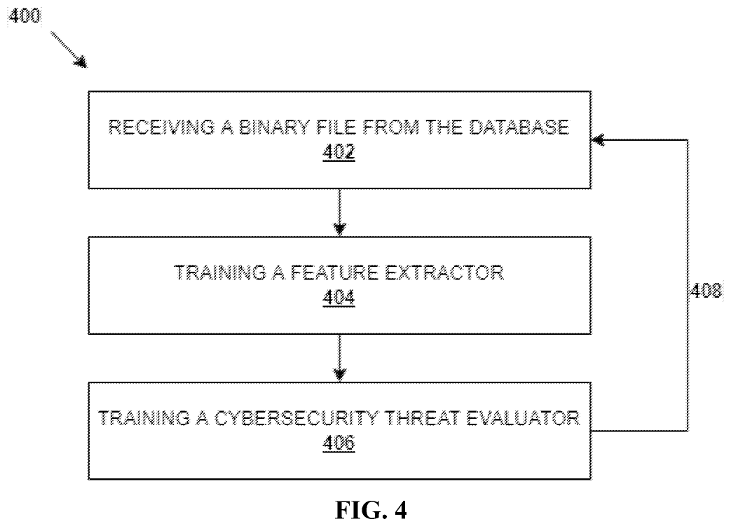

In various examples, the feature extractor 120 outputs the extracted features to the cybersecurity threat evaluator 140. The extracted features can include the header information, exported functions, imported functions, section information, general file information, one or more images, a result of a natural language processing technique performed on the binary file, or a combination thereof. Using one or more of the extracted features, the cybersecurity threat evaluator 140 evaluates and classifies the binary file received from the database 116. A malware binary classifier 130 determines based upon the extracted features whether the binary file is a benign file or malware. The malware binary classifier 130 may utilize one or more machine learning models to make this determination. The one or more machine learning models may be trained using a machine learning algorithm such as Logistic Regression (LR), Naïve Beyes (NB), K-Nearest Neighbor (KNN), Decision Tree (DT), Ada Boost (AB), Deep Neural Network (DNN), or Random Forest (RF), as described below with respect to FIG. 3, for example. The malware binary classifier 130 generates an output that indicates whether the binary file is determined to be malware or benign. In response to an indication that the binary file is a benign file, the analyzer 117 may transmit an indicator to the database 116 to update an identifier of the binary file. The identifier indicates that the binary file is a benign file, for example. The benign file may be used to train a machine learning model, as described below with respect to FIG. 4.

In some examples, the blockchain network 106 may facilitate completion of the smart contract upon receiving the output that indicates whether the binary file is malware or benign. The result of the smart contract is then transmitted to the contributor 102. If the output indicates the binary file is benign, the result may include a notification that the deposit (which may be in the form of cryptocurrency) is to be retained by the system 100 and no payment is to be made to the contributor 102. Conversely, if the output indicates the binary file is malware, the result may include a notification that the deposit is to be returned, a notification that a payment is to be made (optionally in cryptocurrency), the transmission of the deposit, the transmission of the payment, or a combination thereof. In this manner a contractual transaction between the contributor 102 and the system 100 is executed, whereby the contributor is incentivized and rewarded through appropriate payment for submitting malware specimens for the system and the cybersecurity community to become cognizant of and build safeguards against.

In various examples, the extracted features received are further processed by the cybersecurity threat evaluator 140 to determine whether there are similarities between the binary file and known malware. In some examples, the cybersecurity threat evaluator 140 includes the multi-class classifier 142 which determines whether the extracted features are attributable to a known malware family. The multi-class classifier 142 may utilize one or more convolutional neural network (CNN) models to perform the determination. The one or more CNN models are trained using machine learning techniques as described below with respect to FIG. 3, for example. The multi-class classifier may use the CNN model on an image of the extracted features to determine whether the image includes features that are attributable to a known malware family. In various instances, the cybersecurity threat evaluator 140 includes the advanced persistent threat classifier 144, which determines whether the extracted features 132 are attributable to a known advanced persistent threat (APT). The advanced persistent threat classifier 144 may use a machine learning model to determine whether the extracted features are attributable to a known APT. The one or more machine learning models may be trained using a machine learning algorithm such as Logistic Regression (LR), Naïve Beyes (NB), K-Nearest Neighbor (KNN), Decision Tree (DT), Ada Boost (AB), Deep Neural Network (DNN), or Random Forest (RF), as described below with respect to FIG. 3, for example. In some examples, the cybersecurity threat evaluator 140 includes a clustering classifier 146 which classifies binary files into groups based upon commonalities shared by malware across different families or APTs. The clustering classifiers 146 can classify the extracted features using one or more machine learning clustering models. The one or more machine learning clustering models may be trained using unsupervised machine learning algorithms such as K-means, Mini Batch K-means, Mean Shift, or Birch, as described below with respect to FIG. 3. Those skilled in the art will appreciate that the cybersecurity threat evaluator 140 may include additional classifiers and classification techniques not expressly covered herein without departing from the scope of this disclosure.

The cybersecurity threat evaluator 140 may output the classifications generated from the extracted features as a cybersecurity threat intelligence report 150. The cybersecurity threat intelligence report 150. The cybersecurity threat intelligence report 150 may include mitigation techniques for defending against or reacting to the binary file now flagged as malware. For example, the analyzer 117 may retrieve the mitigation techniques associated with the malware from the database 116. The analyzer 117 may transmit the cybersecurity threat intelligence report 150 to the consumer 154. In some examples, the consumer 154 transmits an electronic payment of a specified price or subscription fee to the analyzer 117. The payment may be in the form of a cryptocurrency transaction. The analyzer 117 transmits the cybersecurity threat intelligence report 150 to the database 116 for retention in a depository and for training purposes, as described below with respect to FIG. 3, for example. The cybersecurity threat intelligence report 150 may include suggested practices to limit the effects of the malware should it reach a user's system, as well as recognition techniques, and related malware or advanced persistent threats. The inclusion of both recognition and mitigation techniques within the cybersecurity threat intelligence report 150 allow for the consumer 154 to prepare a defense prior to an attack from the malware in question, increasing the overall security of the systems that may be targeted.

In various examples, the consumer 154 transmits feedback related to the extracted features, the classifications, or any other portion of the cybersecurity threat intelligence report 150, to the system 100. For example, the consumer 154 transmits the feedback to the analyzer 117. A trainer 160 within the analyzer 117 may use the feedback for further training of the feature extractor 120, the cybersecurity threat evaluator 140, or a combination thereof. The trainer 160 may also transmit and receive information to and from the database 116. The trainer 160 may generate or update one or models used by the feature extractor 120, the cybersecurity threat evaluator 140, or a combination thereof. These update models provided by the trainer 160 enhance the accuracy of the system 100 in real-time.

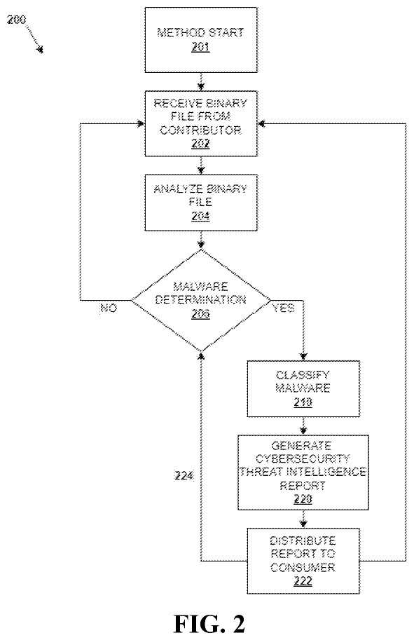

In view of the foregoing structural and functional features described above, example methods will be better appreciated with reference to FIGS. 2-5. While, for purposes of simplicity of explanation, the example methods of FIGS. 2-5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 2 is an example of a method 200 for generating a cybersecurity-threat intelligence report which may be implemented by system 100 in accordance with certain embodiments. The method 200 starts at 201 and includes receiving a binary file from a contributor (e.g., the contributor 102) at 202. The method 200 includes analyzing the binary file at 204. Step 204 may include extracting features with a feature extractor (e.g., the feature extractor 120). At 206, the method 200 includes determining whether the features extracted at step 204 are features of malware or a benign file. In some examples, step 206 may include a binary classification (e.g., using the malware binary classifier 130).

If the binary file is determined to be benign, the analysis of the binary file may be stopped and the method 200 may start again at step 201. If the binary file is found to be malware at step 206, the method 200 continues to a classification step 210. The malware binary file may be classified at 210 relevant to known malware families, known APTs, or other identified commonalities with known malware, using a cybersecurity threat evaluator (e.g., the cybersecurity threat evaluator 140). Utilizing the classifications determined at 210, a cybersecurity threat intelligence report may be generated at 220 (e.g., the cybersecurity threat intelligence report 150). The cybersecurity threat intelligence report may include the classifications, a description of the original binary file, the first date the malware was reported, as well as mitigation techniques relevant to the malware based upon the connections to the known threats. This cyber-intelligence report may be distributed to a consumer at 222 (e.g., the consumer 154). The distribution process may include an exchange of payment or a subscription fee for the consumer to receive a copy of the cyber-intelligence report. The consumer may provide feedback 224 relative to the classifications determined in 210, or the malware determination in 206, and the feedback 224 may be provided to the machine learning techniques or trainers such that the determination and classification processes at 206 and 210 may be improved. Finally, the method 200 may begin again at step 201.

FIG. 3 is an example of a method 300 for performing the transaction between a system (e.g., the system 100), a contributor (e.g., the contributor 102), and a miner (e.g., the miner 110). The method 300 starts at step 301 and includes receiving a binary file from the contributor at 302. As part of the transaction or, in some embodiments, the smart contract, the contributor provides a deposit to the system at 303. The step 303 adds Sybil resistance to the method 300, as the requirement of a deposit may hinder the intentional mass provision of benign files to stall the cybersecurity threat intelligence generation process in a Sybil attack. The blockchain approach presented here additionally provides integrity and traceability to each transaction and submission to further protect the cybersecurity threat intelligence generation process. It should be noted that the steps 302 and 303 may occur in any order, or may occur simultaneously as part of the transaction.

Upon receipt of the binary file and the deposit from the contributor, the transaction is verified at 304. In certain embodiment, the verification of the transaction at 304 involves a miner validating a smart contract on a blockchain. The verification of the transaction at 304 then allows the determination of the malware at 306 which may include feature extraction and malware classification as outline in the method 200. If the binary file is confirmed to be malware, the reliability rating of the contributor may be increased at 318. A reliability limit may be specified by an administrator of the system 100 or other suitable user having a specified level of security authorization. If the contributor's reliability rating is equal to the reliability limit, the attempted increase in reliability rating at 318 will not result in a higher reliability rating. The deposit provided in step 303 may then be returned to the contributor, along with an agreed upon payment, at step 319. Once the transaction completes in this way, the method may begin again at 301, and the contributor may provide another binary file at step 302.

If the binary file is determined to be benign at step 306, the reliability rating of the contributor may be decreased at step 312. The decrease of the reliability rating at 312 may be accompanied with the retention of the deposit provided at 303 in step 313. At 314, the reliability rating of the contributor is compared against a reliability threshold. The reliability threshold is specified by an administrator of the system 100, or other suitable user having a specified level of security authorization. If the contributor's reliability rating fails to meet the reliability threshold, at 316 the contributor is banned from the network to prevent further upload of binary files. While examples described herein decrease the reliability rating at 312 and then assess the reliability rating compared to the reliability threshold at 314, in other examples the threshold comparison at 314 may be performed before decreasing the contributor reliability rating at 312, without departing from the scope of this disclosure. If the contributor's reliability rating meets the reliability threshold, the method 300 may begin again at 301 and the contributor may provide another binary file at step 302.

FIG. 4 is an example of a method 400 for training a feature extractor (e.g., the feature extractor 120) and a cybersecurity threat evaluator (e.g., the cybersecurity threat evaluator 140). The method may be implemented by the trainer 160 from FIG. 1, and as such, the examples of FIG. 3 may reference the examples in FIG. 1 and FIG. 2. The method 400 includes receiving a binary file from the database (e.g., the database 116) at 402. At 404 the feature extractor is trained using the binary file received at step 402. The training at 404 may include training the extractor relative to header extraction, image visualization, string extraction, or any other extraction technique that may aid in the identification of malware.

In some examples, the machine learning algorithms utilized to train the machine learning models at 404 (e.g., the feature extractor 120), at 406 (e.g., the cybersecurity threat evaluator 140), or a combination thereof, may be supervised machine learning algorithms, unsupervised machine learning algorithms, or a combination thereof. As an example, a supervised machine learning classifier algorithm can be a decision tree algorithm, such as a random forest algorithm. In other examples, the supervised machine-learning algorithm can be implemented as a linear classifier algorithm (e.g., a logistic regression, a Naïve Bayes, and/or a Fisher's linear discriminant algorithm), a support vector machine algorithm (e.g., a least squares support vector machine algorithm), a quadratic classifier algorithm, a Kernel estimation algorithm (e.g., K-nearest neighbor algorithm), a neural network algorithm, or a learning vector quantization algorithm. In further examples, an unsupervised machine-learning algorithm can be a K-means algorithm, a Mean Shift algorithm, or a BIRCH algorithm. Those skilled in the art will appreciate that the machine learning algorithm may include additional techniques and algorithms not expressly disclosed herein without departing from the scope of this disclosure.

Using the features extracted in the training of the feature extraction at step 404, the binary file is determined to be malware or a benign file at 406 using a binary classifier (e.g. the malware binary classifier 130). In some examples, the binary file received from the database may be benign to test the capabilities and accuracy of the feature extractor paired with the malware classifier. If the binary file is determined to be malware at 406, the extracted features of the binary file may be used to train the cybersecurity threat evaluator at 406. The training 406 may include training the cybersecurity threat evaluator relative to known malware families (e.g., the multi-class classifier 142), known APTs (e.g., the advanced persistent threat classifier 144), or additional classifications determined based upon similarities between previously trained malware (e.g., the clustering classifier 146). At 408, the method of training may repeat, beginning with receiving a new binary file at 402.

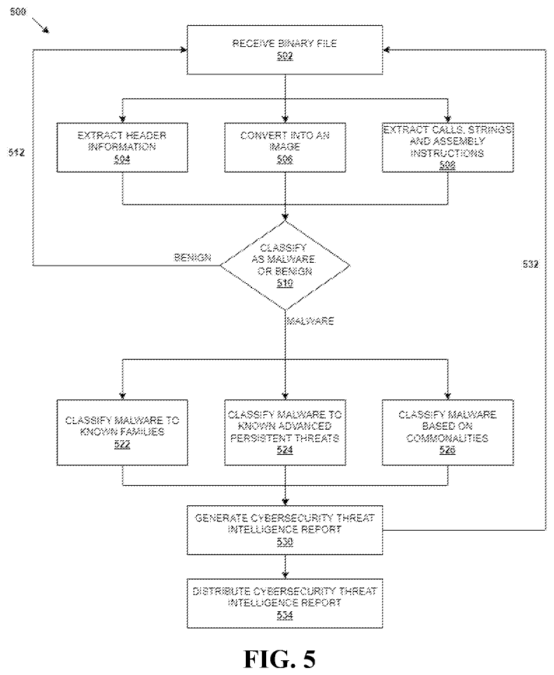

FIG. 5 is an example of a method 500 for generating a cybersecurity threat intelligence report. Upon receiving the binary file at 502 from a source (e.g., the database 116), features of the binary file may be extracted using a number of extraction techniques (e.g., the feature extractor 120). In the present example, information may be extracted from the binary file from the header at 504 (e.g., the header extractor), from image visualization of the binary file at 506 (e.g., the image visualizer 124), and from strings, calls, and assembly instructions at 508 (e.g., the string extractor 126). However, information may be extracted using any number of extraction techniques without departing from the scope of this disclosure.

As stated above, at 504 the binary file's header information may be extracted for comparison to known threats. The raw information extracted may include, but is not limited to, exported functions, imported functions, section information, and general file information that may be stored in the header of the binary file. At 506 the binary sequence of the binary file may be converted into one or more color model images for further analysis. The color model images may be grayscale images, red-green-blue (RGB) images, or hue-saturation-value (HSV) images, for example. The generated image may be used to build or further train a vision-based malware recognition model. At 508 features may be extracted relative to natural language processing (NLP) by performing Sentiment Analysis on API calls made by the binary file, character strings within the binary file, and assembly-language instructions performed as a result of executing the binary file, for example. The character strings may be generated using an encoding technique such as ASCII format, a Unicode format, ANSI format, or other suitable technique for encoding data. While software files may not be written in natural language, the aspects and representations of software may still be considered a form of language. In this way, NLP may be employed to extract features that may be judged based on the sentiment of the extracted information as benign or malicious.

After feature extraction is performed, the extracted features may be used at 510 to classify the binary file as either malware or benign. The classification performed at 510 may be done using binary classifiers (e.g. the malware binary classifier 130) which can utilize machine learning models to make this determination. The one or more machine learning models may be trained using a machine learning algorithm such as Logistic Regression (LR), Naïve Beyes (NB), K-Nearest Neighbor (KNN), Decision Tree (DT), Ada Boost (AB), Deep Neural Network (DNN), or Random Forest (RF), as described below with respect to FIG. 3, for example. These machine learning techniques may incorporate, but are not limited to, analysis of the header information extracted at 504, vision-based malware recognition using the image generated at 506, or NLP analysis using the extracted calls, strings, and instructions extracted at 508. The determination at 510 additionally determines if the method is to continue to the classification stage, or whether to cease the analysis of the binary file and return a flagger 512 to the database signifying the binary file as benign.

In the present example, if the binary file is classified as malware at 510, the extracted features may be employed in the classification of the malware into known malware families at 522 (e.g., the multi-class classifier 142), the classification of the malware into known APTs at 524 (e.g., the advanced persistent threat classifier 144), and/or the classification of the malware based on general commonalities with other threats at 526 (e.g., the clustering classifiers 146). However, the extracted features may be employed in any number of classifications without departing from the scope of this disclosure.

As stated above, at 522 the malware binary file may be classified into any known families of malware using the features extracted at 504, 506, and/or 508. The classification into known families may utilize convolutional neural network models, which receive images as inputs. These models may utilize the image visualized at 506, as well as any manipulated forms of the additionally extracted information that may have been visualized. At 524, the malware may be classified into any known APTs using any number of machine learning models which may analyze the previously extracted features. At 526 the malware may be classified into any group of known threats that share characteristics not currently known, but that may be determined by machine learning algorithms and artificial intelligence. To this end, at 526, unsupervised machine learning clustering models may be utilized which may have an ability to determine correlations and groupings not obvious to the human mind.

Upon the completion of the classification steps, the classifications may be used at 530 to generate a cybersecurity threat intelligence report (e.g., the cybersecurity threat intelligence report 150) which may include the classifications, general information about the binary file, and mitigation techniques for the malware based upon the relations to known threats determined in the classifications. The generated cybersecurity threat intelligence report 532 may be delivered back to the source for future use in training and correlations. Additionally, at 534, the cybersecurity threat intelligence report may be distributed to any number of devices or users (e.g., the consumer 154). The distribution at 534 may include providing the report to consumers for a fee, or may be distributed in-house within an enterprise or cyber ecosystem to bring attention to employees or IT professionals about new cybersecurity threats. This advanced distribution 534 of the information before the malware reaches a system may allow for each entity to establish and update its security policy prior to the malicious file entering the environment.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 6. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

The system described herein can include one or more wired and/or wireless networks, including, but not limited to: a cellular network, a wide area network (“WAN”), a local area network (“LAN”), a combination thereof, and/or the like. One or more wireless technologies that can be included within the system described herein can include, but are not limited to: wireless fidelity (“Wi-Fi”), a WiMAX network, a wireless LAN (“WLAN”) network, BLUETOOTH® technology, a combination thereof, and/or the like. For instance, the system described herein can include the Internet and/or the Internet of Things (“IoT”). In various examples, the system described herein can include one or more transmission lines (e.g., copper, optical, or wireless transmission lines), routers, gateway computers, and/or servers, such as described herein. Further, the system and components of the system described herein can include one or more network adapters and/or interfaces (not shown) to facilitate communications with other components of the system.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 6 illustrates one example of a computer system 600 that can be employed to execute one or more embodiments of the present disclosure. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient, processing capabilities.

Computer system 600 includes processing unit 602, system memory 604, and system bus 606 that couples various system components, including the system memory 604, to processing unit 602. Dual microprocessors and other multi-processor architectures also can be used as processing unit 602. System bus 606 may be any of several types of bus structure including a memory, bus or memory controller, a peripheral bus, and a local bus using any of a variety of bus architectures. System memory 604 includes read only memory (ROM) 610 and random access memory (RAM) 612. A basic input/output system (BIOS) 614 can reside in ROM 610 containing the basic routines that help to transfer information among elements within computer system 600.

Computer system 600 can include a hard disk drive 616, magnetic disk drive 618, e.g., to read from or write to removable disk 620, and an optical disk drive 622, the reading CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and computer-executable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 610, including operating system 632, one or more application programs 634, other program modules 636, and program data 638. In some examples, the application programs 634 can include feature extractors, cybersecurity threat evaluators, report generators, and other machine learning techniques, and the program data 638 can include extracted features, generated classifications, generated cybersecurity threat intelligence reports, and mitigation strategies. The application programs 634 and program data 638 can include functions and methods programmed to receive and analyze a binary file, and generate a cybersecurity threat intelligence report, such as shown and described herein.

A user may enter commands and information into computer system 600 through one or more input devices 640, such as a pointing device (e.g., a mouse, touch screen), keyboard, microphone, joystick, game pad, scanner, and the like. These and other input devices 640 are often connected to processing unit 602 through a corresponding port interface 642 that is coupled to the system bus, but may be connected by other interfaces, such as a parallel port, serial port, or universal serial bus (USB). One or more output devices 644 (e.g., display, a monitor, printer, projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and a wide area network (WAN). When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, application programs 634 or program data 638 depicted relative, to computer system 600, or portions thereof, may be stored in a remote memory storage device 654.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method comprising:
receiving a binary file from a contributor on a blockchain network using a contractual transaction incentivizing malware submission by the contributor;
analyzing the binary file for malicious features; and
generating a cybersecurity threat intelligence report based on said analyzing.

2. The method of claim 1, wherein analyzing the binary file comprises receiving the binary file by a feature extractor operable to extract one or more features based on one or more of analyzing the binary file using one or more of a header of the binary file, an image visualization of the binary file, natural language processing of application programming interface (API) calls, encoded strings, assembly instructions of the binary file, and sentiment analysis, and
wherein the method further comprises delivering an extracted feature to a threat evaluator.

3. The method of claim 2, wherein analyzing the binary file comprises:
receiving the binary file by a feature extractor operable to extract one or more features, and
wherein the method further comprises delivering an extracted feature to a threat evaluator, the threat evaluator operable to classify the binary file based upon one or more of:
comparison to a database of known threats;
inclusion of features that are attributable to a known malware family;
attributability to a known advanced persistent threat (APT); and
clustering based upon commonalities shared by other malware.

4. The method of claim 3, further comprising applying one or more machine learning models to the classification of the binary file, the one or more machine learning models trained using machine learning algorithms selected from Logistic Regression (LR), Naïve Beyes (NB), K-Nearest Neighbor (KNN), Decision Tree (DT), Ada Boost (AB), Deep Neural Network (DNN), or Random Forest (RF).

5. The method of claim 3, wherein classification is a multi-class classification, the method further comprising applying convolutional neural network (CNN) on an image of extracted features of the binary file to determine whether the features that are attributable to a known malware family.

6. The method of claim 1, wherein the binary file is transacted through a smart contract that includes a deposit from the contributor which is returned in response to the binary file containing malicious features.

7. The method of claim 1, further comprising:
assigning a reliability rating to the contributor;
increasing the reliability rating in response to the binary file containing malicious features; and
decreasing the reliability rating in response to the binary file lacking malicious features.

8. The method of claim 1, further comprising:
receiving feedback from a consumer of the cybersecurity threat intelligence report; and
updating analysis of binary files based upon the feedback.

9. A non-transitory computer-readable medium storing machine-readable instructions, which, when executed by a processor of an electronic device, cause the electronic device to:
receive a binary file from a contributor on a blockchain network using a contractual transaction incentivizing malware submission by the contributor;
analyze the binary file for malicious features; and
generate a cybersecurity threat intelligence report based on said analyzing.

10. The non-transitory computer-readable medium of claim 9, wherein analyzing the binary file comprises receiving the binary file by a feature extractor operable to extract one or more features based on one or more of analyzing the binary file using one or more of a header of the binary file, an image visualization of the binary file, natural language processing of application programming interface (API) calls, encoded strings, assembly instructions of the binary file, and sentiment analysis, and
wherein the method further comprises delivering an extracted feature to a threat evaluator.

11. The non-transitory computer-readable medium of claim 10, wherein analyzing the binary file comprises:
receiving the binary file by a feature extractor operable to extract one or more features, and
wherein the method further comprises delivering an extracted feature to a threat evaluator, the threat evaluator operable to classify the binary file based upon one or more of:
comparison to a database of known threats;
inclusion of features that are attributable to a known malware family;
attributable to a known advanced persistent threat (APT); and
clustering based upon commonalities shared by other malware.

12. The non-transitory computer-readable medium of claim 11, wherein the instructions, when executed by the processor of the electronic device, further cause the electronic device to apply one or more machine learning models to the classification of the binary file, the one or more machine learning models trained using machine learning algorithms selected from Logistic Regression (LR), Naïve Beyes (NB), K-Nearest Neighbor (KNN), Decision Tree (DT), Ada Boost (AB), Deep Neural Network (DNN), or Random Forest (RF).

13. The non-transitory computer-readable medium of claim 11, wherein classification is a multi-class classification, the method further comprising applying convolutional neural network (CNN) on an image of extracted features of the binary file to determine whether the features that are attributable to a known malware family.

14. The non-transitory computer-readable medium of claim 9, wherein the binary file is transacted through a smart contract that includes a deposit from the contributor which is returned in response to the binary file containing malicious features.

15. The non-transitory computer-readable medium of claim 9, wherein the instructions, when executed by the processor of the electronic device, further cause the electronic device to:
assign a reliability rating to the contributor;
increase the reliability rating in response to the binary file containing malicious features; and
decrease the reliability rating in response to the binary file lacking malicious features.
